(19) United States
(12) Patent Application Publication
(10) Pub. No.: US 2025/0286052 A1
(43) Pub. Date: Sep. 11, 2025

(54) CATHODE LAYER

(71) Applicant: TOYOTA JIDOSHA KABUSHIKI KAISHA, Toyota-shi, Aichi-ken (JP)

(72) Inventor: Ryosuke OHSAWA, Okazaki-shi, Aichi-ken (JP)

(73) Assignee: TOYOTA JIDOSHA KABUSHIKI KAISHA, Toyota-shi, Aichi-ken (JP)

(21) Appl. No.: 18/893,001

(22) Filed: Sep. 23, 2024

(30) Foreign Application Priority Data
Sep. 28, 2023 (JP) 2023-168744

(51) Int. Cl. H01M 4/525; H01M 4/02; H01M 4/131; H01M 4/505; H01M 4/62; H01M 10/0525

(52) U.S. Cl. CPC H01M 4/525; H01M 4/131; H01M 4/505; H01M 4/625; H01M 10/0525; H01M 2004/028

(57) ABSTRACT

A main object of the present disclosure is to provide a cathode layer capable of suppressing an initial-resistance of a battery. The present disclosure achieves the object by providing a cathode layer to be used for a lithium ion secondary battery, the cathode layer comprising: a cathode active material and a carbon nanotube, wherein the cathode active material contains a lithium-nickel-based complex oxide including at least a Li element, a Ni element, an O element, and an X element of which valence is 1 or 2 (excluding Li element and Ni element), and a tungsten present in at least one of inside or on the surface of the lithium-nickel-based complex oxide; the cathode active material is a secondary particle including a plurality of primary particles and a void formed among the plurality of primary particles; the cathode layer contains, as the carbon nanotube, a first carbon nanotube, at least partially included in the secondary particle; and when a spectrum in a position (10195 eV to 10206 eV) where a peak of L absorption edge of tungsten measured by an X-ray absorption fine structure analysis (XAFS) satisfies below: formula (1): (a−b)/(c−b)≤0.79; [in the formular (1), “a” represents an energy (eV) at the time when a slope of the spectrum in the range of 10195 eV to 10206 eV is the maximum; and when A designates a spectral intensity in the “a” (eV), “b” represents an energy (eV) where a spectral intensity in WO₂ (tungsten oxide (IV)) in the range of 10195 eV to 10206 eV is the A; and “c” represents an energy (eV) where a spectral intensity of WO₃ (tungsten oxide (VI)) in the range of 10195 eV to 10206 eV is the A.]

### TECHNICAL FIELD

The present disclosure relates to a cathode layer to be used for a lithium-ion secondary battery.

### BACKGROUND ART

A lithium-ion secondary battery has been put into practical use not only in small power supplies such as mobile phones and notebook computers, but also in medium and large power supplies such as automotive applications and power storage applications.

In order to improve the performance of a lithium-ion secondary battery, a study focused on a cathode active material has been attempted. For example, to provide a non-aqueous electrolyte secondary battery having a low initial-resistance and suppressing an increase in resistance when charging and discharging are repeated, patent literature 1 discloses a non-aqueous electrolyte secondary battery comprising a positive electrode, wherein, as a cathode active material, the positive electrode includes porous particles having specific porosity, containing two or more voids, and having a coating layer containing tungsten oxide (WO₃, hexavalent tungsten) and lithium tungstate on their surface.

Patent Literature 2 discloses a cathode to be used for a lithium-ion secondary battery using a cathode active material containing tetravalent tungsten.

### CITATION LIST

### Patent Literatures

Patent Literature 1: Japanese Patent Application Laid-Open (JP-A) No. 2021-018895
Patent Literature 2: JP-A No. 2023-082743

### SUMMARY OF DISCLOSURE

### Technical Problem

In a battery using a cathode active material containing tungsten, an effect of suppressing initial resistance of the battery is expected. On the other hand, there is room for further improvement in suppressing the initial resistance.

The present disclosure has been made in view of the above circumstances, and an object of the present disclosure is to provide a cathode layer capable of suppressing an initial-resistance of a battery.

### Solution to Problem

[1]

A cathode layer to be used for a lithium ion secondary battery, the cathode layer comprising:
a cathode active material and a carbon nanotube, wherein
the cathode active material contains a lithium-nickel-based complex oxide including at least a Li element, a Ni element, an O element, and an X element of which valence is 1 or 2 (excluding Li element and Ni element), and a tungsten present in at least one of inside or on the surface of the lithium-nickel-based complex oxide;
the cathode active material is a secondary particle including a plurality of primary particles and a void formed among the plurality of primary particles;
the cathode layer contains, as the carbon nanotube, a first carbon nanotube, at least partially included in the secondary particle; and
when a spectrum in a position (10195 eV to 10206 eV) where a peak of L absorption edge of tungsten measured by an X-ray absorption fine structure analysis (XAFS) satisfies below:

(a−b)/(c−b)≤0.79; formula (1):

[in the formular (1), “a” represents an energy (eV) at the time when a slope of the spectrum in the range of 10195 eV to 10206 eV is the maximum; and
when A designates a spectral intensity in the “a” (eV),
“b” represents an energy (eV) where a spectral intensity in WO₂ (tungsten oxide (IV)) in the range of 10195 eV to 10206 eV is the A; and
“c” represents an energy (eV) where a spectral intensity of WO₃ (tungsten oxide (VI)) in the range of 10195 eV to 10206 eV is the A.] [2]

The cathode layer according to [1], wherein the lithium-nickel-based complex oxide contains at least one of Na, K, Rb, Cs, Be, Mg, Ca, Sr, and Ba as the X element.

[3]

The cathode layer according to [1] or [2], wherein a molar ratio of the X element to the Ni element in the lithium-nickel-based complex oxide is 0.05 or more and 0.13 or less.

[4]

The cathode layer according to any one of [1] to [3], wherein in the lithium-nickel-based complex oxide, a mean valence of the Ni element is 2.90 or more and 3.50 or less.

[5]

The cathode layer according to any one of [1] to [4], wherein the lithium-nickel-based complex oxide contains at least Be as the X element.

### Advantageous Effects of Disclosure

According to the present disclosure, it is possible to provide a cathode layer capable of suppressing an increase in battery resistivity.

### BRIEF DESCRIPTION OF DRAWINGS

FIGS. 1A and 1B are schematic cross-sectional views illustrating a cathode active material in the present disclosure.

FIG. 2 is a diagram for explaining the formula (1) in the present disclosure.

FIG. 3 is a diagram for explaining the formula (1) in the present disclosure.

### DESCRIPTION OF EMBODIMENTS

Hereinafter, cathode layers will be described in detail. In the present specification, the term “-” indicating a numerical range is used to include numerical values described before and after the numerical range as a lower limit value and an upper limit value.

### 1. Cathode Layer

Cathode layer used in the lithium-ion secondary battery includes a cathode active material and a carbon nanotube. Cathode active material contains a lithium nickel-based composite oxide containing at least a Li element, a Ni element, an O element, and an X element having a valence of 1 or 2 (excluding Li element and Ni element), and tungsten present in at least one of the inside and the surface of the lithium nickel-based composite oxide. Cathode active material is a secondary particle having a plurality of primary particles and a void formed between the plurality of primary particles. Cathode layer contains, as the carbon nanotube, a first carbon nanotube including at least a part of the voids of the secondary particles. Furthermore, cathode layers satisfy Equation (1): (a−b)/(c−b)≤0.79 as measured by X-ray absorb microstructure analysis (XAFS). In this specification, the “voids formed between the primary particles” may be referred to as “voids of the secondary particles”. In addition, the “void space of the secondary particles” usually means an internal space of the secondary particles surrounded by a plurality of primary particles.

Since cathode active material contains a lithium-nickel-based complex oxide containing a predetermined X element and tungsten, cathode layers containing cathode active material can suppress battery.

As cathode active material, for example, it is known to use lithium-nickel-based complex oxides such as NCM and NCA. On the other hand, since nickel ions (Ni²⁺) have close ionic radii to lithium ions (Li⁺), cation mixing may occur between lithium ions and nickel ions. Cationic mixing can inhibit the migration of lithium-ions during battery charging and discharging, increasing battery resistivity.

Also known are tungsten-containing cathode active material. Here, as will be described in detail later, when the above equation (1) is satisfied, the valence of the tungsten contained in cathode active material is tetravalent or has a mean valence between tetravalent and hexavalent, so that battery resistance such as the initial resistance can be suppressed.

In this regard, the present inventors have found that cationic mixing may be accelerated in a cathode active material including tungsten and a lithium-nickel-based complex oxide, and there is room for further improvement in suppressing battery resistivity. This is because Ni may not be sufficiently oxidized due to tungsten. In contrast, in cathode active material disclosed herein, since the lithium-nickel-based complex oxide contains an X element having a valence of 1 or 2, the valence of Ni can be increased (Ni can be sufficiently oxidized). As a consequence, cationic mixing can be suppressed, and battery resistivity can be suppressed from increasing. In the lithium-nickel-based complex oxide represented by LiNi_{0.9}X_{0.1}O₂, when the valence of X is tetravalent, the valence (mean valence) of Ni is 2.89, but when the valence of X is trivalent, the valence of Ni is 3.00.

### (1) Cathode Active Material

Cathode active material in the present disclosure contains a Li element, a Ni element, an O element, X element whose valence is 1 or 2 (excluding Li elements and Ni elements), and a lithium-nickel-based complex oxide at least containing. Note that the X element is a so-called typical element having no valence other than 1 or 2.

The lithium nickel-based composite oxide may contain, as the X element, only an element having a valence of 1, or only an element having a valence of 2, or may contain both an element having a valence of 1 and an element having a valence of 2. The lithium nickel-based composite oxide preferably contains at least an element having a valence of 2 as the X element.

Examples of the element X include an alkali metal element and an alkaline earth metal element. Examples of the X element include Na, K, Rb, Cs, Be, Mg, Ca, Sr, and Ba. The lithium nickel-based composite oxide may contain one or two or more of the above-described elements as the X element.

In the lithium-nickel-based complex oxide, the molar ratio of the X element to Ni element is, for example, 0.05 or more, may be 0.06 or more, or may be 0.07 or more. On the other hand, the molar ratio of the X element to Ni element is, for example, 0.13 or less, may be 0.12 or less, or may be 0.10 or less.

In the lithium-nickel-based complex oxide, the molar ratio of the X element to Li element is, for example, 0.01 or more, and may be 0.03 or more. On the other hand, the molar ratio of the X element to Li element is, for example, 0.1 or less, may be 0.07 or less, or may be 0.05 or less.

The lithium-nickel-based complex oxide may further contain transition metal elements such as Mn, Co and Al. The molar ratio of Ni element to all transition metal elements in the lithium-nickel-based complex oxide is preferably 0.5 or more. The molar ratio of Ni element to all transition metal elements may be 0.6 or more and may be 0.7 or more. On the other hand, the molar ratio of Ni element to all transition metal elements is, for example, 0.9 or less.

In the lithium-nickel-based complex oxide, Ni element preferably has a higher mean valence.

The mean valence of Ni element is, for example, 2.90 or more, may be 2.95 or more, and may be 3.00 or more. Meanwhile, the mean valence of Ni element is, for example, 3.50 or less, may be 3.30 or less, and may be 3.10 or less.

The lithium-nickel-based complex oxide may be, for example, represented by Li [NiₐMe_{b}X_{(1-a-b)}]O₂: In the above formula, a satisfies 0.5≤a<1.0, b satisfies 0≤b<0.5. Me is at least one element of Mn, Co and Al, and X is the X element described above.

The lithium-nickel-based complex oxide constitutes a primary grain to be described later in cathode active material.

In addition, cathode active material contains tungsten.

The tungsten contained in cathode active material may be tetravalent tungsten, or may be a mixture of tetravalent tungsten and hexavalent tungsten in which the spectrum including 10195 eV˜10206 eV of the L-absorption edge of the tungsten satisfies Expression (1) to be described later.

Examples of the tetravalent tungsten compound include WO₂, lithium tungstate containing tetravalent tungsten, and lithium nickel cobalt manganese-based complex oxide containing tetravalent tungsten.

Examples of the hexavalent tungsten compound include lithium tungstate containing hexavalent tungsten such as WO₃, Li₂WO₄, and lithium nickel cobalt manganese-based complex oxide containing hexavalent tungsten.

The content of tungsten (the content of tungsten in the entire cathode active material) is not particularly limited, but is, for example, 0.1 mass % or more, may be 0.3 mass % or more, or may be 0.5 mass % or more. On the other hand, the content of tungsten is, for example, 1.0 mass % or less, may be 0.8 mass % or less, or may be 0.6 mass % or less. When the content of tungsten is within the above range, battery resistivity of the lithium-ion secondary battery can be further reduced. The content of tungsten can be determined by elemental analysis by ICP (radio frequency inductively coupled plasma) emission spectrometry.

Further, the tungsten is present in at least one of the inside and the surface of the lithium-nickel-based composite oxide. In cathode active material, tungsten may be present inside the lithium-nickel-based complex oxide. For example, the tungsten may be present as a component constituting the lithium-nickel-based composite oxide, or may be dispersed inside the lithium-nickel-based composite oxide. As described above, both of the lithium-nickel-based complex oxide and the tungsten may constitute the primary grains of cathode active material. In cathode active material, tungsten may be present on the surface of the lithium-nickel-based complex oxide. That is, the tungsten may be present so as to cover the surface of the primary particles (the primary particles of the lithium nickel-based composite oxide) in cathode active material, or may be present so as to cover the surface of the secondary particles (the secondary particles of the lithium nickel-based composite oxide). The tungsten may be present in both the inside and the surface of the lithium-nickel-based composite oxide.

Cathode active material is a secondary particle having a plurality of primary particles and a void formed between the plurality of primary particles.

The primary particles may have voids. In other words, the primary particles may be porous particles. The voids are the same as those in the secondary particles described later.

Average particle size (D₅₀) of the primary grains is, for example, 0.01 μm or more and 100 μm or less. Average particle size (D₅₀) refers to a cumulative 50% particle size in a volume-based particle size distribution by a laser diffractive particle size distribution analyzer.

The secondary particles have voids. The void ratio (porosity) is not particularly limited, but is, for example, 20% or more and 50% or less. The porosity can be determined, for example, by observing the cross section of cathode active material by scanning electron microscopy (SEM). The porosity can also be determined by measuring the pore distribution using a mercury porosimeter.

In addition, the voids may have a predetermined average pore size (radii), and the average pore size is, for example, equal to or larger than 1 nm and equal to or smaller than 500 nm. The average fine pore size may be determined, for example, by a mercury porosimeter measurement.

Average particle size (D₅₀) of the secondary-particle system is, for example, 0.1 μm or more and 1000 μm or less. Average particle size (D₅₀) is the same as described above.

The ratio of cathode active material in cathode layers is not particularly limited, but is, for example, 50% by mass or more and 90% by mass or less.

Cathode active material of method for producing in the present disclosure is not particularly limited as long as the above-described cathode active material can be obtained, and examples thereof include the methods described in the following Examples.

### (2) Carbon Nanotubes (CNT)

Cathode layers comprise carbon nanotubes. Carbon nanotubes function as conductive materials.

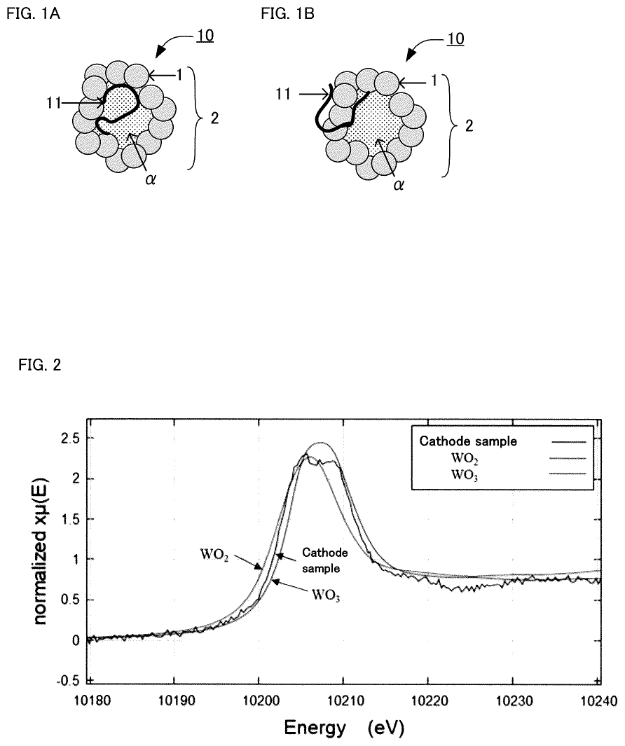

Cathode layers contain, as carbon nanotubes, a first carbon nanotube at least partially contained in the voids of the secondary particles. Here, the position of the carbon nanotube will be described with reference to FIG. 1. FIG. 1 is a schematic cross-sectional view illustrating a cathode active material according to the present disclosure. As shown in FIG. 1A, in cathode active material 10, all of the first carbon nanotubes 11 may be included in the voids a (inside) of the secondary particles 2 formed by the aggregation of the primary particles 1. On the other hand, as shown in FIG. 1B, a part of the first carbon nanotube 11 may exist in the void a (inside) of the secondary particle 2, and a part thereof may exist in the outside (outer surface) of the secondary particle.

Examples of the method of incorporating the first carbon nanotube in the voids of the secondary particles include the methods described in Examples described below.

Cathode layers may contain, as carbon nanotubes, second carbon nanotubes that are not included in the voids of the secondary particles.

The second carbon nanotube can be contained in cathode layer by adding the carbon nanotube at the time of manufacturing cathode mixture in the embodiment described later.

The ratio of the first carbon nanotube and the second carbon nanotube in cathode layer is not particularly limited. When the mass of the first carbon nanotube is X1 and the mass of the second carbon nanotube is X2, X1/X2 is, for example, 0.1 or more and 3 or less.

The proportion of the carbon nanotube in cathode layer is not particularly limited, but is, for example, 0.5% by mass or more and 20% by mass or less.

### (3) Cathode Layer

In cathode layer, the spectrum of the peak-rising position (10195 eV˜10206 eV) of the L-absorption edge of tungsten measured by X-ray absorption microstructure analysis (XAFS) is expressed as follows:

(a−b)/(c−b)≤0.79 Equation (1):

[In Equation (1), a represents eV when the slope of the spectrum becomes largest in 10195 eV˜10206 eV range.]
When the spectral strength in a (eV) is taken as A,
b represents eV at which the spectral strength is A over 10195 eV˜10206 eV of WO₂ (IV)
c represents eV at which the spectral strength is A over 10195 eV˜10206 eV of WO₃ (VI).] is satisfied.

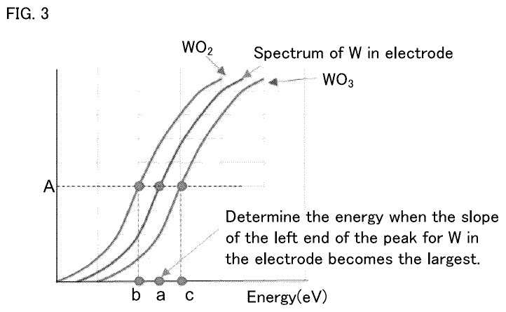

Here, the above formula (1) will be described with reference to FIGS. 2 and 3. FIG. 2 is a XAFS measured spectrum of cathode layers (cathode samples), WO₂, and WO₃. Specifically, FIG. 2 shows a spectrum including the peak-rising position (10195 eV˜10206 eV) of the L-absorption edge of tungsten as measured by XAFS of cathode samples, WO₂ (tungsten oxide (IV)) and WO₃ (tungsten oxide (VI)). FIG. 3 is a partially enlarged view of the peak-rising position of the L-absorption edge of tungsten in XAFS measured spectrum of cathode samples, WO₂, and WO₃.

The rising position of the peak at the L-absorption edge of the tungsten in XAFS measured spectrum is assumed to represent the valence of the element of the tungsten. In the present disclosure, in the rising position (10195 eV˜10206 eV) of the peak at the L-absorption edge of the tungsten in XAFS measured spectrum of cathode sample, the energy (eV) at the time when the slope of the spectrum becomes the largest is defined as a, and is used as an index of the peak rising position. A can be identified as the peak-top energy of the derivative by differentiating the spectrum of the scope of 10195 eV˜10206 eV. When the spectral intensity in a (eV) is A, the energy (eV) at which the spectral intensity is A in the range of 10195 eV˜10206 eV of WO₂ (tungsten oxide (IV)) is b, and the energy (eV) at which the spectral intensity is A in the range of 10195 eV˜10206 eV of WO₃ (tungsten oxide (VI)) is c. Here, WO₂ is used as a standard sample of tetravalent tungsten, and WO₃ is used as a standard sample of hexavalent tungsten.

In Equation (1), when (a−b)/(c−b)=1, the tungsten in cathode layer (in cathode active material) is interpreted to be hexavalent. In Equation (1), when (a−b)/(c−b)=0, the tungsten in cathode layers is interpreted to be tetravalent. In Equation (1), when (a−b)/(c−b)≤0.79 is satisfied, the tungsten in cathode layers is tetravalent or is interpreted as having a mean valence between tetravalent and hexavalent.

Tungsten having an average valence between tetravalent and hexavalent is considered to be a mixture of tetravalent tungsten and hexavalent tungsten, and has an average valence lower than that of hexavalent tungsten, and has a high conductivity and an effect of lowering the active energy. Therefore, if the tungsten in cathode layers is tetravalent or has a mean valence between tetravalent and hexavalent, the tungsten can reduce the cell resistance by reducing the conductivity and the active energy. In addition, tungsten having a lower valence tends to be dissolved in Ni, Co, Mn used for cathode active material or the like, and when it is dissolved in a solid solution, it is considered that the diffusion-resistance of lithium ions can be reduced by widening the crystal axis of the crystal-structure of cathode active material.

(a−b)/(c−b) in Equation (1) may be 0.70 or less, may be 0.60 or less, or may be 0.50 or less. On the other hand, (a−b)/(c−b) in Equation (1) is, for example, 0.20 or more, may be 0.30 or more, or may be 0.40 or more. XAFS for determining (a−b)/(c−b) in Equation (1) will be described in the following examples.

Cathode layers may contain at least one of an electrolyte and a binder in addition to cathode active material and carbon nanotubes described above. Cathode layers may contain a conductive material other than the carbon nanotubes.

The electrolyte may be a liquid-based electrolyte or a solid electrolyte. Examples of the liquid-based electrolyte include an electrolyte including organic solvents such as ethylene carbonate (EC), dimethyl carbonate (DMC), and ethyl methyl carbonate (EMC), and a support salt such as LiPF₆. Examples of solid electrolyte include mineral solid electrolyte such as oxide solid electrolyte and sulfide solid electrolyte. Examples of the binder include a rubber binder and a fluoride binder. Examples of the conductive material other than carbon nanotubes include particulate carbon materials such as acetylene black (AB) and Ketjen black (KB), and fibrous carbon materials such as carbon nanofibers (CNF).

The thickness of cathode layers is not particularly limited, but is, for example, 0.1 μm or more and 1000 μm or less.

Method for producing of cathode layers is not particularly limited, and examples thereof include methods in which a cathode mixture including at least the above-described cathode active material (a cathode active material in which a first carbon nanotube is enclosed in a void space of a secondary particle) is applied to a substrate such as cathode current collector and dried. At least one of a carbon nanotube (second carbon tube), a binder, a conductive material, and an electrolyte may be added to cathode mixture.

### 2. Lithium-Ion Secondary Battery

Cathode layers are used in a lithium-ion secondary battery. Therefore, in this disclosure, it is also possible to provide a lithium ion secondary battery, which is a lithium ion secondary battery with an electrolyte layer located between cathode layer and anode layer, and cathode layer described above. The lithium-ion secondary battery generally includes a cathode current collector for collecting a cathode layer and a anode current collector for collecting a anode layer. The lithium-ion secondary battery may be a liquid-based battery containing a liquid-based electrolyte as an electrolyte, or may be a solid-based battery containing solid electrolyte as an electrolyte.

Cathode layers are as described in “1. cathode layers”. Anode layers, the electrolyte layers, cathode current collector, and anode current collector may be conventionally known members used in a lithium-ion secondary battery.

Applications of the lithium-ion secondary battery include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used for a power supply for driving a hybrid electric vehicle (HEV), a plug-in hybrid electric vehicle (PHEV), or a battery electric vehicle (BEV). Battery may be used as a power source for a moving object (for example, a railroad, a ship, or an airplane) other than vehicles, or may be used as a power source for an electric appliance such as an information processing device.

Note that the present disclosure is not limited to the above-described embodiment. The above-described embodiment is an example, and any one having substantially the same configuration as the technical idea described in the claims in the present disclosure and having the same operation and effect is included in the technical scope of the present disclosure.

### EXAMPLES

### Example 1

### (Preparation of Cathode Active Material)

A cathode active material including a lithium-nickel-based complex oxide and tungsten was prepared in the following manner.

First, a source of Ni element (nickel sulfate), a source of Co element (cobalt sulfate), a source of Mn element (manganese sulfate), and a source of X element (beryllium sulfate) were dissolved in ion-exchanged water to prepare an aqueous raw material solution (density 30 wt %). On the other hand, a reaction solution in which pH was adjusted using sulfuric acid and ammonia-water was prepared in the reaction vessel. In addition, an aqueous sodium hydroxide solution was prepared as a pH adjusting solution. Then, the raw material aqueous solution was added to the reaction solution at a predetermined rate while stirring, and neutralized with pH adjusting solution. The crystallized material was washed with water, filtered, and dried to obtain composite hydroxide particles (precursor particles). The drying was performed at 120° C. for 16 hours.

The obtained precursor particles and lithium carbonate were mixed. The molar ratio of lithium to the total of nickel, cobalt, manganese and beryllium was 1.1. The mixture was calcined in an electric furnace at 870° C. for 15 hours. After cooling in a furnace to room temperature, crushing treatment was performed to obtain a lithium-nickel-based complex oxide (Li (Ni_{0.8}Co_{0.1}Mn_{0.05}Be_{0.05})O₂)), which is a spherical fired powder (secondary particles) in which primary particles were aggregated. Incidentally, when the obtained lithium nickel-based composite oxide was observed under a microscope, it was confirmed that sufficient gaps (voids of the secondary particles) were present between the primary particles.

The obtained lithium nickel-based composite oxide, tungsten oxide (IV) (WO₂), and tungsten oxide (VI) (WO₃) were mixed at a ratio of tungsten (W/(lithium nickel-based composite oxide+WO₂+WO₃)) to 0.5 wt %. Cathode active material was obtained as a lithium-nickel-based complex oxide having a coating of tungsten oxide (WO₂, WO₃) by treating the mixture with a mechanochemical device at 3000 rpm for 30 minutes and further heat treatment at 150° C. for 1 hour.

The resulting cathode active material was also analyzed by transmission electron microscopy-energy dispersive X-ray spectroscopy (TEM-EDX). As a result, it was clarified that tungsten was incorporated in the primary particle of the lithium metal composite oxide. That is, in the obtained cathode active material, tungsten was present both inside and on the surface of the lithium-nickel-based complex oxide.

### (Preparation of Cathode Layers)

The obtained cathode active material and the conductive material (carbon nanotube) and the binder (polyvinylidene fluoride) were weighed in a mass ratio of cathode active material:conductive material:binder=88:10:2, and these were mixed to obtain cathode mixture. The mixing was performed for 10 minutes by charging cathode mixture and 1% by weight of zirconia balls (diametrical 3.0 mm) with respect to cathode mixture by a kneading device (manufactured by Shinkey Corporation). The resulting cathode mixture was coated on a cathode current collector (Al foil) with a film applicator (with film thickness adjusting function, ALGAL CO., LTD) and then dried at 80° C. for 5 minutes. This gave cathode structures with cathode current collector and cathode layers.

### (Preparation of Battery for Evaluation (Lithium-Ion Secondary Battery)

A anode active material layer-forming paste was prepared by mixing natural graphite (C) as a anode active material, styrene butadiene rubber (SBR) as a binder, and carboxymethyl cellulose (CMC) as a thickener in ion-exchanged water at a C:SBR:CMC=98:1:1 weight ratio. The pastes were applied to both surfaces of a 10-μm-thick anode current collector (Cu foil), dried, and pressed to produce a anode structure having anode layers on both surfaces of anode current collector.

As a separator sheet, two 24-μm-thick porous polyolefin sheets each having a PP/PE/PP three-layer structure were prepared. The prepared cathode structure, anode structure, and the prepared two separator-sheets were superposed and wound to produce a wound electrode body. Electrode terminal was welded to each of cathode and anode of the wound electrode body prepared, and this was accommodated in a battery case having an injection port.

### Example 2 and Example 3

An evaluation battery was prepared in the same manner as in Example 1, except that cathode active material was prepared using magnesium sulfate or calcium sulfate as the X element source. The ratios and valences of Ni element, Co element, Mn element, and the X element in the lithium-nickel-based complex oxide are shown in FIG. 1.

### Comparative Example

An evaluation battery was prepared in the same manner as in Example 1, except that cathode active material was prepared without using an X element source. The ratios and valences of Ni element, Co element, and Mn element in the lithium-nickel-based complex oxide are shown in Table 1.

### [Evaluation]

### (SEM Observations)

Cathode layers obtained in Examples and Comparative Examples were subjected to cross-sectional using a cross-polisher. The obtained cross-section was observed using a FE-SEM (Field Emission Scanning Electron Microscope) to confirm the position of the carbon nanotubes in cathode layers. The results are shown in Table 2. As shown in Table 2, in each of the Examples and Comparative Examples, the carbon nanotubes were present on both the surface and the inside of the active material. That is, cathode layers in the Examples and Comparative Examples contained both the first carbon nanotube and the second carbon nanotube.

### (X-Ray Absorb Microstructure Analysis (XAFS) of Cathode Layers)

Cathode obtained in the Examples and Comparative Examples were measured by XAFS using the device described below. In addition, tungsten oxide (IV) (WO₂) and tungsten oxide (VI) (WO₃) of the reference sample were also measured by XAFS using the following device. From the spectrum of the peak rising position (10195 eV˜10206 eV) of the L-absorption edge of tungsten measured by XAFS, (a−b)/(c−b) in the above equation (1) was determined. The results are shown in Table 2.

Equipment: Aichi Synchrotron Optical Center Inner Hard X-ray XAFS, Scientific and Technological Exchange Foundation
Measuring range: 9897-11297 eV (peak position of L-absorption edge of tungsten)

Cathode was measured by a fluorescent method and tungsten compounds were measured by a transmission method.

The transmission method for measuring the tungsten compound of the reference material detects the transmitted X-rays when the incident X-rays are irradiated, and the fluorescence method for measuring cathode detects the fluorescent X-rays generated when the incident X-rays are irradiated, and can be expressed as the same spectrum even if the measurement method is different. By normalizing the measured XAFS using the analysis software Athena, the tungsten of the tungsten compound of the reference material can be compared with the tungsten in cathode.

In order to obtain the reproducibility of Equation (1), the reference sample was measured for cathode sample, and the minute deviation was corrected.

### (Initial Resistance Evaluation)

Battery prepared in the Examples and Comparative Examples were subjected to an activation treatment as described below, and then the initial resistance was measured. Battery was placed in an ambient at 25° C. The activation (initial charge) was performed using a constant-current-constant-voltage method. After battery for assessment was charged to 4.2V at ⅓ C current value, the constant-voltage charge was performed until the current value became 1/50 C, and the fully charged state was established. Thereafter, battery for the respective valuation was constant-current discharged to 3.0V at the current of ⅓ C. In this manner, the respective battery for assessment were activated.

The respective battery subjected to the activation treatment were adjusted to the open circuit voltage of 3.70V. This was placed in a temperature environment of −28° C. The current of 20 C was discharged for 8 seconds, and the voltage-drop ΔV was obtained.

Next, the voltage drop ΔV was divided by the discharging current (20 C) to calculate battery resistance, and this was used as the initial resistance. The initial resistance of each of the comparative examples was set to 100%, and the initial resistance of each of the examples was relatively evaluated. The results are shown in Table 2.

### (Evaluation of Ni Mixing Ratio)

Cathode layers prepared in Examples and Comparative Examples were subjected to metallic content evaluation by ICP-MS and crystal-structure evaluation by XRD. Ni mixing ratio was calculated by the Rietveld analysis. The results are shown in Table 2.

TABLE 1

| | Ni | | Co | | Mn | | X | | |
|---|---|---|---|---|---|---|---|---|---|
| | Ratio | Valence | Ratio | Valence | Ratio | Valence | Kind | Ratio | Valence |
| Comp. Ex | 0.8 | 2.88 | 0.1 | 3 | 0.1 | 4 | — | 0 | — |
| Example 1 | 0.8 | 3.00 | 0.1 | 3 | 0.05 | 4 | Be | 0.05 | 2 |
| Example 2 | 0.8 | 3.00 | 0.1 | 3 | 0.05 | 4 | Mg | 0.05 | 2 |
| Example 3 | 0.8 | 3.00 | 0.1 | 3 | 0.05 | 4 | Ca | 0.05 | 2 |

TABLE 2

| | | | | Initial |
|---|---|---|---|---|
| | | Location of | Ni mixing | resistance |
| | (a-b)/(c-d) | CNT | (mol %) | (%) |
| Comp. Ex | 0.77 | Surface and interior | 3.5 | 100 |
| | | of active material | | |
| Example 1 | 0.78 | Surface and interior | 1.5 | 86 |
| | | of active material | | |
| Example 2 | 0.76 | Surface and interior | 2.1 | 93 |
| | | of active material | | |
| Example 3 | 0.75 | Surface and interior | 2.3 | 95 |
| | | of active material | | |

As shown in Tables 2, Ni mixing ratio of each of the examples was smaller than that of the comparative examples, and the initial-resistance was suppressed. From this, it was shown that cathode layers in the present disclosure can suppress the resistivity of battery. In addition, as shown in Table 2, in Examples and Comparative Examples, (a−b)/(c−d) was 0.79 or less, indicating that tungsten in cathode layers is tetravalent or has a mean valence between tetravalent and hexavalent.

### REFERENCE SINGS LIST

1 Primary particle
2 Secondary particle
10 Cathode active material
11 First carbon nanotube

What is claimed is:

1. A cathode layer to be used for a lithium ion secondary battery, the cathode layer comprising:
a cathode active material and a carbon nanotube, wherein
the cathode active material contains a lithium-nickel-based complex oxide including at least a Li element, a Ni element, an O element, and an X element of which valence is 1 or 2 (excluding Li element and Ni element), and a tungsten present in at least one of inside or on the surface of the lithium-nickel-based complex oxide;
the cathode active material is a secondary particle including a plurality of primary particles and a void formed among the plurality of primary particles;
the cathode layer contains, as the carbon nanotube, a first carbon nanotube, at least partially included in the secondary particle; and
when a spectrum in a position (10195 eV to 10206 eV) where a peak of L absorption edge of tungsten measured by an X-ray absorption fine structure analysis (XAFS) satisfies below:
(a−b)/(c−b)≤0.79; formula (1):
[in the formular (1), “a” represents an energy (eV) at the time when a slope of the spectrum in the range of 10195 eV to 10206 eV is the maximum; and
when A designates a spectral intensity in the “a” (eV),
“b” represents an energy (eV) where a spectral intensity in WO₂ (tungsten oxide (IV)) in the range of 10195 eV to 10206 eV is the A; and
“c” represents an energy (eV) where a spectral intensity of WO₃ (tungsten oxide (VI)) in the range of 10195 eV to 10206 eV is the A.]

2. The cathode layer according to claim 1, wherein the lithium-nickel-based complex oxide contains at least one of Na, K, Rb, Cs, Be, Mg, Ca, Sr, and Ba as the X element.

3. The cathode layer according to claim 1, wherein a molar ratio of the X element to the Ni element in the lithium-nickel-based complex oxide is 0.05 or more and 0.13 or less.

4. The cathode layer according to claim 1, wherein in the lithium-nickel-based complex oxide, a mean valence of the Ni element is 2.90 or more and 3.50 or less.

5. The cathode layer according to claim 1, wherein the lithium-nickel-based complex oxide contains at least Be as the X element.
